(19) United States
(12) Patent Application Publication
(10) Pub. No.: US 2007/0137498 A1
(43) Pub. Date: Jun. 21, 2007

(54) Portable cooking unit assembly

(76) Inventor: Richard T. Sarich, West Allis, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/286,592

(22) Filed: Nov. 23, 2005

Related U.S. Application Data
(60) Provisional application No. 60/631,355, filed on Nov. 29, 2004.

(51) Int. Cl. A47J 37/04

(52) U.S. Cl. 99/419

(57) ABSTRACT

A portable rotisserie cooking unit assembly having a first support base providing an electric drive motor and a second support base for supporting a rotating cooking spit driven by the electric drive motor. The cooking unit also includes physical features which allow the first and second pyramid support bases to interlock and engage one another when transportation of the first and second pyramid support bases is desired or required.

### REFERENCE TO PRIOR APPLICATION

This application claims the benefit of U.S. Provisional Application No. 60/631,355, filed Nov. 29, 2004.

### FIELD OF THE INVENTION

This invention relates generally to portable cooking units. More particularly, it relates to a portable rotisserie cooking unit assembly that has a pair of independently positionable elements that are designed for ease in setting up the cooking unit for use. It also relates to such a cooking unit whereby the elements of the assembly need not be placed in precise linear arrangement in order to achieve proper operation of the cooking unit. It also relates to a cooking unit configuration whereby the elements of the assembly can be interlockingly engageable for ease in transport of the unit between cooking sites.

### BACKGROUND OF THE INVENTION

Rotisserie cooking units are well known in the art. The applicant has, in fact, been previously granted U.S. Pat. No. 5,367,950 (the '950 patent) for a vertical heat source rotisserie. While the rotisserie that is the subject of the '950 patent is still very much in use, applicant has found that there is also a need for a more versatile and more portable alternative rotisserie cooking unit in comparison to that which is disclosed and claimed in his '950 patent. For example, it would be desireable to have a rotisserie cooking unit assembly that assumes a relatively small physical profile when the unit is not in use and when the unit is being transported by the user from one cooking location to another. It would also be desireable to have a rotisserie cooking unit assembly that is linearly adjustable such that the support ends of the cooking unit assembly are able to be movable relative to one another so as to accommodate a variety of spit sizes. In this fashion, the same cooking unit assembly could be used for cooking a whole pig or just a few chickens. It would also be desireable to have such a rotisserie cooking unit where the support ends of the cooking unit need not be situated in precisely the same horizontal plane, or even be completely horizontal or level, in order to achieve proper operation of the unit. In the experience of this inventor, the reality of setting up for an outdoor cook-out often requires that the cooking unit be situation on the ground where surface topography is less than ideal. Other desireable attributes of the cooking unit assembly envisioned by this inventor are that the unit be easily assembled and disassembled in the field, that the unit be comprised of a minimal number of elements, that the unit be easily usable, that the unit deflect heat generated under the spit and between the support ends away from the electrical rotisserie drive components of the unit, and that the unit be easily cleanable for repeated use.

### SUMMARY OF THE INVENTION

It is, therefore, a principal object of this invention to provide a new, useful and uncomplicated rotisserie cooking unit assembly that is completely portable and that requires only a minimal number of elements and only a minimal number of steps to assemble and disassemble in the field. It is another object of this invention to provide such a cooking unit assembly which, once assembled, is easily utilized in the field to uniformly cook meat and which, because of its configuration, ensures the uniform cooking of the meat and the like. It is still another object of this invention to provide such a device which is collapsible and occupies a much smaller volume when disassembled than when assembled. It is yet another object of the invention to provide a cooking unit assembly having a rather compact configuration when the unit is completely disassembled and when it is transported. It is still another object of this invention to provide such a device which is able to be set up on uneven horizontal surfaces, which surfaces are typically encountered in the outdoors.

The present invention has obtained these objects. It provides for a portable rotisserie cooking unit assembly having a first pyramid shaped support base. The first pyramid shaped support base includes an electrical drive motor and a first spit support. The cooking unit assembly also includes a second pyramid support base having a second spit support. The shape of the first and second spit supports enhances the stability of each when in use. The first and second spit supports are opposed longitudinally from one another during normal use of the cooking unit. The first pyramid support base includes a drive mechanism that is thermally insulated from the heat source used with the cooking unit. The first and second pyramid support bases are also independently configured so as to allow the unit to rest on uneven surfaces. In this fashion, the cooking unit assembly can be used in a number of outdoor settings. The cooking unit also includes physical features which allow the first and second pyramid support bases to interlock and engage one another when transportation of the first and second pyramid support bases is desired or required. These and other features of the cooking unit assembly of the present invention will be further apparent from the detailed description that follows.

### BRIEF DESCRIPTION OF THE DRAWINGS

FIG. 1 is a front, top and right side perspective view of a portable cooking unit assembly constructed in accordance with the present invention.

FIG. 2 is a front, top and left side perspective view of the portable cooking unit assembly illustrated in FIG. 1.

FIG. 3 is an enlarged front, top and left side perspective view of a first pyramid support base used in the assembly shown in FIG. 1.

FIG. 4 is an enlarged front, top and right side perspective view of a second pyramid support base used in the assembly shown in FIG. 1.

FIG. 5 is a further enlarged rear, top and left side perspective view of the first pyramid support base illustrated in FIG. 3 and showing a partial cut-away view of the motor housing.

FIG. 6 is a further enlarged and cross-sectioned left elevational view of the first pyramid support base shown in FIG. 3.

FIG. 7 is a front elevational view of the assembly illustrated in FIG. 1, without the spit, and showing the support bases connected together for transport and relocation by the user.

### DETAILED DESCRIPTION

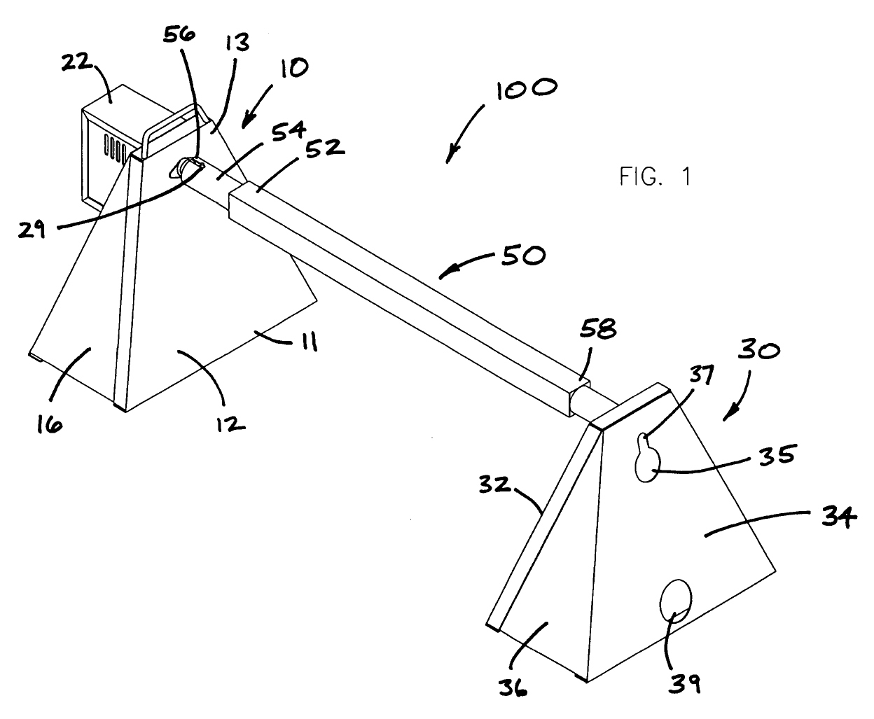

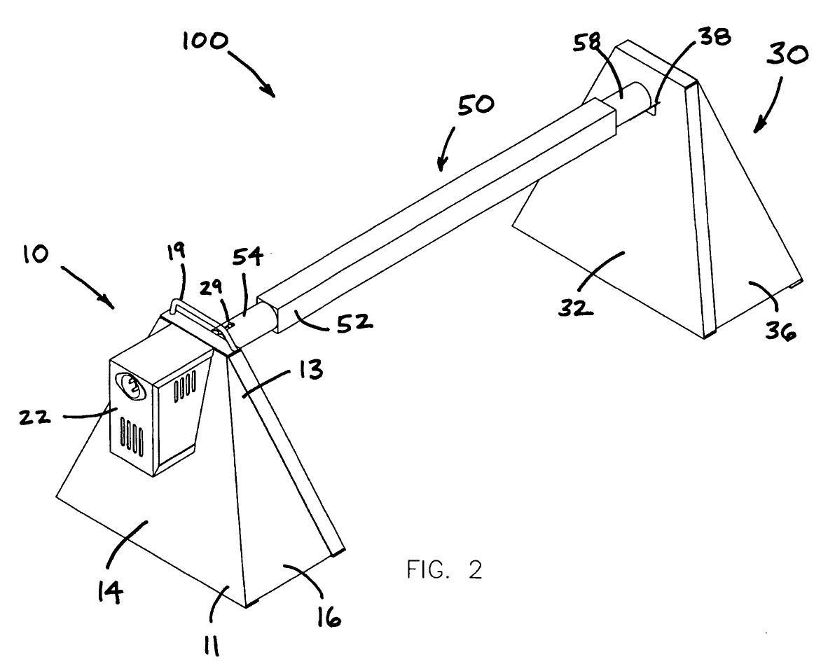

Referring now to the drawings in detail, wherein like numbers represent like elements throughout, FIGS. 1 and 2 illustrate perspective views of the portable cooking unit assembly of the present invention when used as intended. As shown, the portable cooking unit assembly, generally identified 100, is generally comprised of a first pyramid support base 10 and a second pyramid support base 30. Disposed longitudinally and extending between the first and second pyramid support bases 10, 30 is a spit assembly 50. Though not shown, it is to be understood that a heat source, such as ignited charcoal briquettes, wood chips, or other suitable combustibles, is situated beneath the spit assembly 50 and between the support bases 10, 30. It is also to be understood that the assembly 100 is intended to rest upon the ground or any other generally horizontal surface. For example, the assembly 100 could be set up within a trough-like container (not shown) that is elevated off of the ground without deviating from the scope of the present invention.

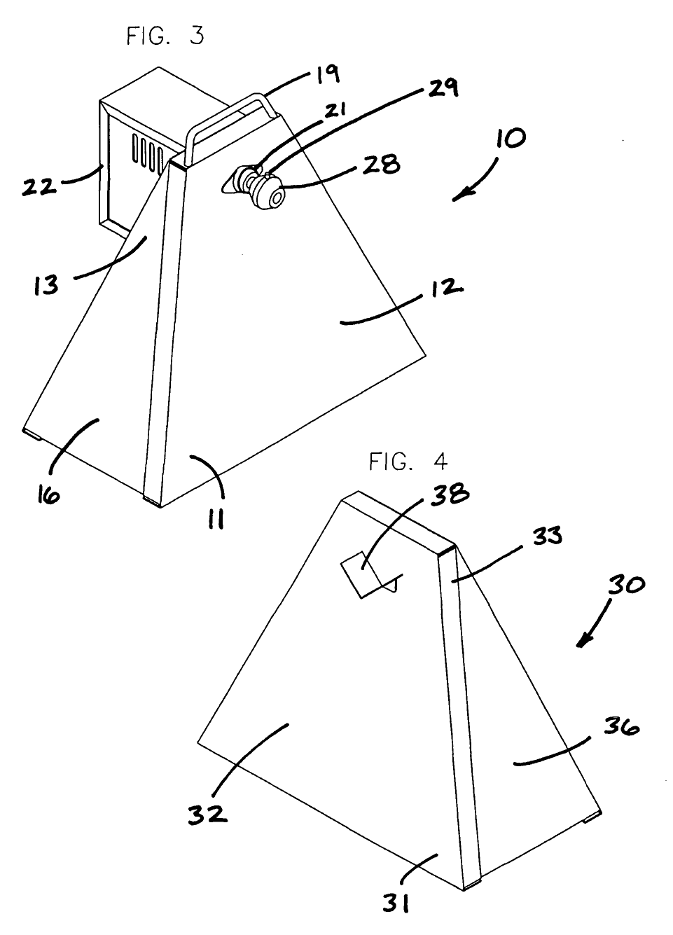

Referring again to FIGS. 1 and 2, it will be seen that the first pyramid support base 10 includes a front face portion 12, a rear face portion 14 and a pair side face portions 16. See, also, FIG. 3. The taper of the front and rear face portions 12, 14 relative to the vertical is about 15 degrees in the preferred embodiment. This precise angle is not, however, a limitation of the cooking unit assembly of the present invention. The primary reason for tapering the face portions 12, 14, 16 of the first pyramid support base 10 inwardly is to improve the stability of the first support base 10 and to improve overall stability of the unit 100. This aspect of the present invention will be more apparent later in this detailed description.

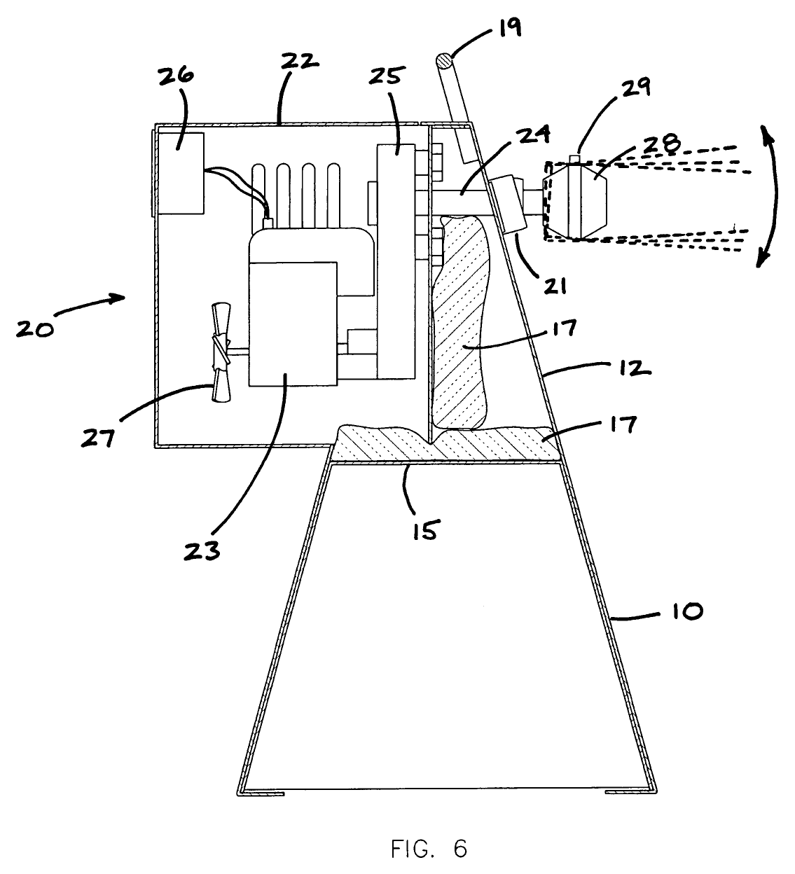

The first pyramid support base 10 also includes an upper first base portion 13 and a lower first base portion 11. The lower portion 11 of the first pyramid support base 10 is functionally adapted to rest upon the ground. A handle 19 extends upwardly from the upper first base portion 13. Extending upwardly from the lower base portion 11 and outwardly of the rear face portion 14 of the first pyramid support base 10 is a motor housing 22. Mounted within the housing 22 is a motor drive assembly, generally identified 20. See FIG. 5. The motor drive assembly 20 includes an AC electric motor 23, a gear box 25 and a generally horizontally disposed drive shaft 24 extending from the gear box 25. A motor fan 27 is also provided as is a male electrical receptacle 26. See FIG. 6. The drive shaft 24 extends through the upper portion 13 of the first pyramid support base 10 and outwardly from the front face portion 12. The shaft 24 is supported at the face 12 by means of a self-aligning bearing 21. Attached adjacent the front face portion 12 and at the end of the shaft 24 is a ball joint 28. The ball joint 28 is attached to the shaft 24 by means of a pin 29. At shown, the distal end of the pin 29 is allowed to extend outwardly from the ball joint 28, generally perpendicularly to the axis of the shaft 24. The purpose of this configuration will be further apparent later in this detailed description.

Internally of the first pyramid support base 10 is a heat shield 15 and an adjacent insulation blanket 17 which prevents radiant heat from entering into that portion of the first pyramid base 10 that includes the motor assembly 20. In this way, the motor assembly 20 is heat insulated and will not stop due to the tripping of the thermal overload device (not shown) contained within the motor 23. This also insures longer motor 23 life. In the preferred embodiment, the insulation blanket 17 is made of a ceramic wool fiber. One such fiber is SUPERWOOL® brand fiber (SUPERWOOL is a registered trademark of The Morgan Crucible Company plc).

The second pyramid support base 30 similarly includes a front face portion 32, a rear face portion 34 and a pair of side face portions 36. Here again, the taper of each of the front face portion 32 and the rear face portion 34 relative to the vertical is approximately 15 degrees but is not a limitation of the present invention. In this regard, the second pyramid support base 30 is a virtual mirror image of the first pyramid support base 10, which creates an aesthetically pleasing appearance for the cooking unit 100 in addition to one that is inherently stable.

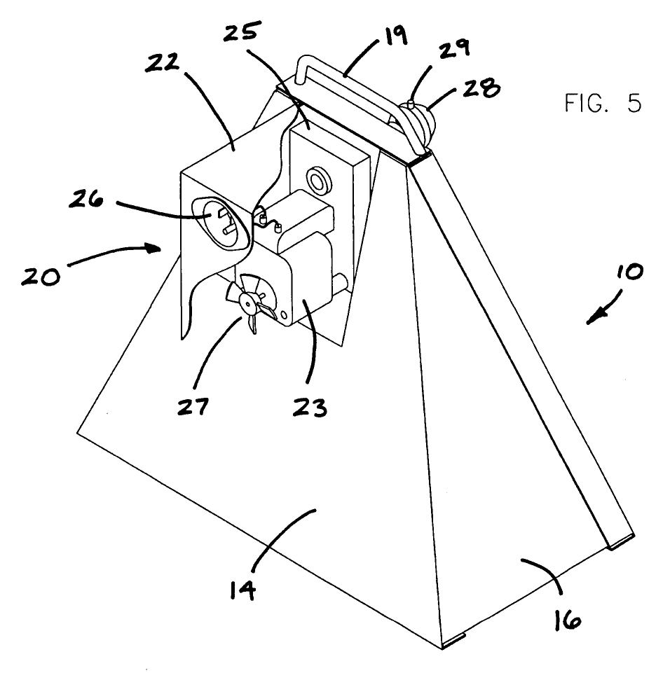

The second pyramid support base 30 also includes a lower second base portion 31 and an upper second base portion 33. Extending outwardly from the front face 32 of the second pyramid base 30 is a spit support 38. See FIG. 4. In the preferred embodiment, the spit support member 38, as shown, comprises nothing more than a pair of intersecting flat flanges extending outwardly from the front face portion 32 of the second pyramid support base 30 in a generally V-shape at 90° relative to one another. In this fashion, one end of the spit assembly 50 can rest upon and freely rotate within the spit support member 38. The second pyramid support base 30 may also include one or more apertures 39 to aid in heat dissipation. See FIG. 1. The number and placement of such apertures 39 is not a limitation of the present invention.

Extending between the first pyramid base 10 and the second pyramid base 30 is a spit assembly 50. See FIGS. 1 and 2. The spit assembly 50 may be configured in a number of sizes and lengths. That is, one spit assembly 50 may be long enough that a whole pig may be secured to the spit assembly 50. Another spit assembly 50 may be relatively shorter, the length of the spit assembly not being a limitation of the present invention. What is a limitation of the invention is the fact that an almost limitless number of spit assembly 50 lengths may be used with the cooking unit 100 of the present invention.

The first end 52 of the spit assembly 50 includes a sleeve 54 having at least one slot 56 defined within it. The opposing end 58 of the spit does not include such a sleeve nor is such required in the preferred embodiment. The first end 52 of the spit assembly 50 is functionally adapted to enclose the ball joint 28 of the motor assembly 20 with one end of the pin 29 extending through the slot 56 as previously defined. In this fashion, rotation of the ball joint 28 and the pin 29 effects a rotation of the sleeve 54 and the first end 52 of the spit assembly 50. As alluded to earlier, the second end 58 of the spit assembly 50 rests upon the spit support 38 that extends from the front face 32 of the second pyramid base 30. In this fashion, rotation of the spit assembly 50 by virtue of rotation of the ball joint 28 and pin 29 results in rotation of the second end 58 of the spit assembly 50 within the spit support 38.

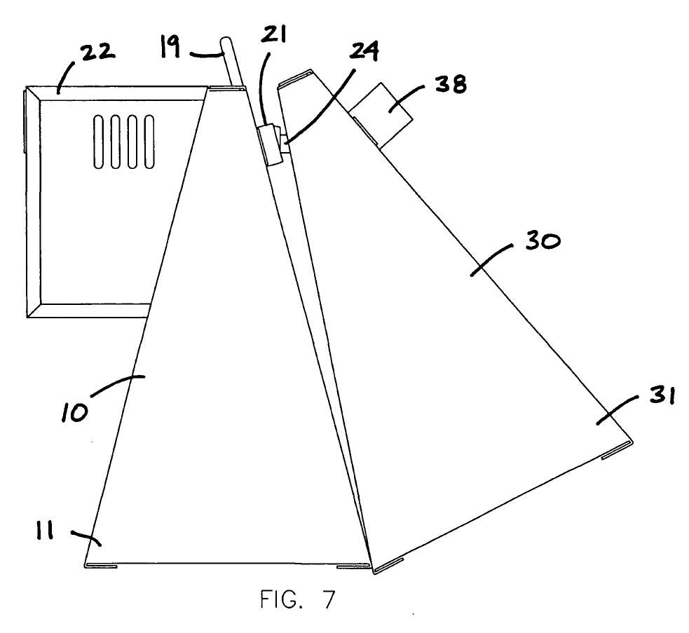

In application, the first and second pyramid support bases 10, 30, respectively, may be engaged with one another by virtue of an aperture 35 defined within the rear face 34 of the second pyramid support base 30. See FIG. 1. In this fashion, the first and second pyramid support bases 10, 30 may be transported using the handle 19 as a single unit 100. See FIG. 7. As shown, the aperture 35 of the second pyramid support base 30 includes a slot 37 that extends upwardly from the aperture 35 for engaging the shaft 24 and ball joint 28 of the first pyramid support base 10. Upon arrival to the selected cooking site, the first and second pyramid support bases 10, 30 are disengaged from one another. The first pyramid support base 10 is placed in a first location. The second pyramid support base 30 is placed in a second location and positioned such that the front face 32 of the second support base 30 faces the front face 12 of the first support base 10. In this fashion, the ball joint 28 of the first support base 10 is directly opposite the spit support 38 of the second support base 30 such that the spit assembly 50 can be placed to extend between them. With the desired heat source generated and located between the first and second support bases 10, 30, and with the desired grilling subject mounted to the spit assembly 50, the spit assembly 50 is placed on the unit 100. This is accomplished by placing the sleeve 54 over the ball joint 28, the slot 56 of the sleeve 54 receiving the pin end 29, and then lowering the second end 58 of the spit assembly 50 onto the spit support 38. The electrical motor assembly 20 is then actuated to cause the spit assembly 50 to rotate as such is desired or required until the grilling subject is cooked to the liking of the user. When cooking is completed, the spit assembly 50 is removed from the unit 100, the first and second support bases 10, 30 are removed from the vicinity of the heat source and are interlockingly engaged and carried off to the next cooking location.

Based on the foregoing, it will be seen that there has been provided a new, useful and uncomplicated rotisserie cooking unit assembly that is completely portable and that requires only a minimal number of elements and only a minimal number of steps to assemble and disassemble in the field; that, once assembled, is easily utilized in the field to uniformly cook meat and that, because of its configuration, ensures the uniform cooking of the grilling subject and the like; that is collapsible and occupies a much smaller volume when disassembled than when assembled; that has a rather compact configuration when the unit is completely disassembled and when it is transported; that is able to be set up and be used on uneven horizontal surfaces, which surfaces are typically encountered in the outdoors.

What is claimed is:

1. A portable rotisserie cooking unit comprising:
a first support base, the first support base including a motor, a gear box and a drive shaft, the drive shaft having a first end attached to the gear box and a second end extending outwardly from the first support base;
a second support base; the second support base including a spit support;
a spit assembly, the spit assembly extending between the first support base and the spit support on the second support base.

2. The portable rotisserie cooking unit of claim 1 wherein the drive shaft of the first support base is supported in the first support base by a self-aligning bearing.

3. The portable rotisserie cooking unit of claim 1 wherein a ball joint is attached to the second end of the driveshaft.

4. The portable rotisserie cooking unit of claim 3 wherein the ball joint is attached to the second end of the driveshaft by a pin, the pin protruding from the ball joint.

5. The portable rotisserie cooking unit of claim 4, the spit assembly being comprised of a sleeve and a having a first end, the first end of the sleeve having at least one slot defined therewithin, the sleeve fitting over the ball joint and the pin fitting within the slot defined within the sleeve.

6. The portable rotisserie cooking unit of claim 1, the spit support member of the second base being comprised of a generally V-shaped flange.

7. The portable rotisserie cooking unit of claim 1 wherein the second base assembly includes a plurality of apertures to aid in heat dissipation.

8. The portable rotisserie cooking unit of claim 1 wherein the first base assembly has a handle extending upwardly from the first base assembly.

9. The portable rotisserie cooking unit of claim 1 wherein the second support base has a front face and a rear face, the rear face including a generally circular aperture, the aperture containing a slot extending upwardly from the aperture, the aperture and slot accommodating the ball joint and pin such that the first and second support bases can be transported using the handle.

10. The portable rotisserie cooking unit of claim 1 wherein the first support base further includes a cooling fan.

11. The portable rotisserie cooking unit of claim 1 wherein an insulating blanket prevents radiant heat from entering that portion of the first support base that contains the motor.

12. A portable rotisserie cooking unit comprising:
a first support base, the first support base having a front face and a rear face and a handle extending upwardly therefrom, the first support base including:
a motor;
a gear box;
a self aligning bearing in the front face of the first support base;
a drive shaft, the drive shaft having a first end attached to the gear box and a second end extending outwardly through the self aligning bearing from the first support base; and
a ball joint attached to the second end of the driveshaft by a pin, the pin protruding from the ball joint;
a second support base further comprising;
a front face including a spit support;
a rear face, the rear face including a generally circular aperture, the aperture containing a slot upwardly from the aperture, the aperture and slot accommodating the ball joint and pin such that the first and second support bases can be transported using the handle;
a spit assembly, the spit assembly extending between the first support base and the second support base.

13. The portable rotisserie cooking unit of claim 12, the spit assembly being comprised of a sleeve and a having a first end, the first end of the sleeve having at least one slot defined therewithin, the sleeve fitting over the ball joint and the pin fitting within the slot defined within the sleeve.

14. The portable rotisserie cooking unit of claim 12, the second base having a spit support member comprising a generally V-shaped flange.

15. The portable rotisserie cooking unit of claim 12 wherein the second base assembly includes a plurality of apertures to aid in heat dissipation.

16. The portable rotisserie cooking unit of claim 12 wherein the first support base further includes a cooling fan.

17. The portable rotisserie cooking unit of claim 12 wherein an insulating blanket prevents radiant heat from entering that portion of the first support base that contains the motor.

18. A portable rotisserie cooking unit comprising:
a pyramidal first support base, the first support base having a front face and a rear face and a handle extending upwardly therefrom, the first support base comprising:
a motor;
a gear box;
a self aligning bearing in the front face of the first support base;
a drive shaft, the drive shaft having a first end attached to the gear box and a second end extending outwardly through the self aligning bearing from the first support base; and
a ball joint attached to the second end of the driveshaft by a pin, the pin protruding from the ball joint;
a pyramidal second support base further comprising;
a front face including a spit support;
a rear face, the rear face including a generally circular aperture, the aperture containing a slot upwardly from the aperture, the aperture and slot accommodating the ball joint and pin such that the first and second support bases can be transported using the handle;
a spit assembly, the spit assembly extending between the first support base and the second support base, the spit assembly comprising:
a sleeve having a first end, the first end of the sleeve having at least one slot defined therewithin, the sleeve fitting over the ball joint and the pin fitting within the slot defined within the sleeve, and
a second end, the second end resting on the spit support.

19. The portable rotisserie cooking unit of claim 18, the second base having a spit support member comprising a generally V-shaped flange.

20. The portable rotisserie cooking unit of claim 18 wherein the second base assembly includes a plurality of apertures to aid in heat dissipation.

21. The portable rotisserie cooking unit of claim 18 wherein the first support base further includes a cooling fan.

22. The portable rotisserie cooking unit of claim 18 wherein an insulating blanket prevents radiant heat from entering that portion of the first support base that contains the motor.
